(19) United States
(12) Patent Application Publication
(10) Pub. No.: US 2026/0045247 A1
(43) Pub. Date: Feb. 12, 2026

(54) AUDIO SPEAKERS ORIENTED FOR CONSTRAINING SOUND TRAVEL

(71) Applicant: Apple Inc., Cupertino, CA (US)

(72) Inventors: Ariel A. MASSIAS, San Francisco, CA (US); Brendan M. BYRNE, Castro Valley, CA (US); John H. SHEERIN, Santa Clara, CA (US); Scott P. PORTER, San Jose, CA (US)

(21) Appl. No.: 18/801,352

(22) Filed: Aug. 12, 2024

(51) Int. Cl. G10K 11/175; H04R 1/22; H04R 1/28; H04R 1/40

(52) U.S. Cl. CPC G10K 11/175; H04R 1/227; H04R 1/2873; H04R 1/403; H04R 2499/15

(57) ABSTRACT

A system includes speaker assemblies in which one speaker assembly emits audible sound that cancels audible sound from another speaker assembly, and conversely, the other speaker assembly emits audible sound that cancels audible sound from the speaker assembly. By causing the sound to cancel or at least partially cancel, the audible sound travel (e.g., distance the sound travels) is limited. Also, when the canceled audible sound includes low-frequency audible sound (e.g., bass), other objects in or near a listening environment are less likely to shake or rattle.

### TECHNICAL FIELD

This application is directed to audio speakers, and more particularly, to audio speakers (e.g., dipole speakers) that provide soundwaves (in the form of audible sound) functioning as self-canceling, or at least partially self-canceling, soundwaves for canceling soundwaves from other audio speakers.

### BACKGROUND

Audio speakers provide audible sound (e.g., acoustical energy, acoustical output) for listening by a user (or users). Some audio speakers are designed to provide low-frequency acoustical output in the form of bass. When generating low-frequency acoustical output, some audio speakers provide significant force, which may result in shaking or rattling of the audio speaker and nearby objects, as well as vibrations (e.g., tactile vibrations) felt by users.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a perspective view of an embodiment of a speaker assembly, in accordance with one or more aspects of the present disclosure.

FIG. 2 illustrates a partial cross sectional view of the speaker assembly shown in FIG. 1, showing additional features of the speaker assembly, in accordance with one or more aspects of the present disclosure.

FIG. 3A and FIG. 3B illustrate partial cross sectional views of alternate embodiments of speaker assemblies, in accordance with one or more aspects of the present disclosure.

FIG. 4 illustrates a perspective view of an environment with multiple speaker assemblies, in accordance with one or more aspects of the present disclosure.

FIG. 5 illustrates a graph showing sound pressure level (SPL) versus frequency for a dipole speaker and for a set of multiple dipole speakers, in accordance with one or more aspects of the present disclosure.

FIG. 6 illustrates a graph showing SPL of soundwaves from a dipole speaker at various distances from a reference point, in accordance with one or more aspects of the present disclosure.

FIG. 7 illustrates a graph showing SPL of soundwaves from multiple dipole speakers at various distances from a reference point, in accordance with one or more aspects of the present disclosure.

FIG. 8 illustrates a perspective view of a speaker assembly that includes multiple sets of audio speakers, in accordance with one or more aspects of the present disclosure.

FIG. 9 illustrates a partial cross sectional view of the speaker assembly shown in FIG. 8, showing additional features of the speaker assembly, in accordance with one or more aspects of the present disclosure.

FIG. 10 illustrates a perspective view of an embodiment of an electronic device, in accordance with one or more aspects of the present disclosure.

FIG. 11 illustrates a flow diagram showing an example of a process for managing audible sound, in accordance with one or more aspects of the present disclosure.

FIG. 12 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to speaker assemblies designed to generate audible sound, in the form of soundwaves, that cancels, or at least partially cancels, with audile sound generated by another speaker assembly. As an example, a first speaker assembly may generate audible sound that at least partially cancels audible sound generated by a second speaker assembly. Additionally, at least some of the audible sound generated by the first speaker is at least partially canceled by the second speaker assembly. In one or more implementations, the canceled audible sound is low-frequency, bass. Accordingly, the canceled audible sound may include a frequency of approximately 200 Hertz (Hz) or less.

By canceling audible sound, speaker assemblies described herein limit sound travel of low frequency audible sound in a listening environment. A system described herein may include multiple sets of speaker assemblies, with each set of speaker assemblies having at least two audio speakers. Moreover, audio speakers of a speaker assembly may cancel audible sound by being oriented to emit audible sound in different directions. In this regard, speaker assemblies described herein may take the form of a dipole speaker. As an example, a dipole speaker includes two audio speakers in which the soundwaves from one of the audio speakers out of phase (e.g., 180 degrees out of phase) with respect to the other audio speaker. Additionally, audio speakers described herein that take the form of dipole speakers may emit, or radiate, respective soundwaves in opposite directions. As a result, for a given set of speaker assemblies, the audible sound emitted may be canceled at one or more locations outside the space between the speaker assemblies, thereby constraining the sound in the listening environment. Beneficially, the audible sound may not travel to unwanted locations outside of the listening environment (e.g., other rooms in a house or offices, etc.). Moreover, canceling low-frequency sound (e.g., bass) may limit or prevent unwanted forces (e.g., mechanical forces from the audio speakers) that otherwise cause objects in the listening environment to shake or rattle.

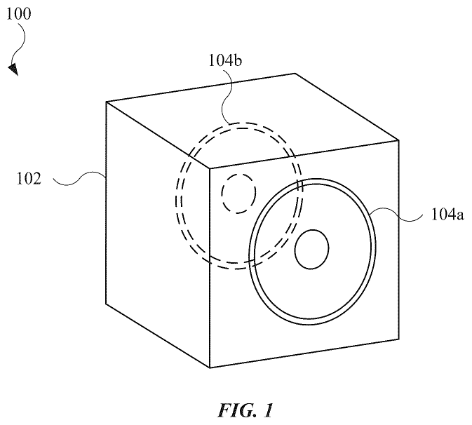

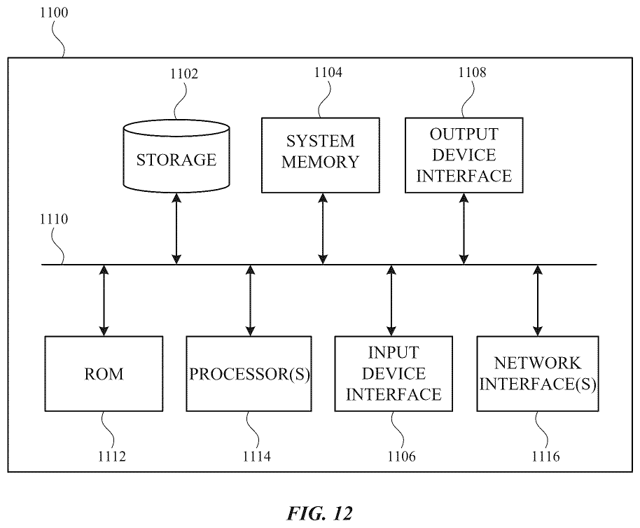

These and other embodiments are discussed below with reference to FIGS. 1-12. However, those skilled in the art will readily appreciate that the detailed description given herein with respect to these Figures is for explanatory purposes only and should not be construed as limiting.

FIG. 1 illustrates a perspective view of an embodiment of a speaker assembly 100, in accordance with one or more aspects of the present disclosure. The speaker assembly 100 is designed to generate soundwaves resulting in audible sound (e.g., soundwaves in the frequency range of human hearing). As non-limiting examples, the speaker assembly 100 (representative of one or more speaker assemblies) may be implemented a consumer electronic device, such as a mobile wireless communication device (e.g., smartphone, tablet computing device), a mixed reality (MR) device (e.g., augmented reality (AR) device, virtual reality (VR) device), or a desktop computing device.

The speaker assembly 100 may include a housing 102, or enclosure, designed to carry several components of the speaker assembly 100. For example, the speaker assembly 100 may include an audio speaker 104a and an audio speaker 104b, each of which is disposed in and carried by the housing 102. Each of the audio speakers 104a and 104b may take the form of a drive unit designed to generate soundwaves to produce audible sound. In one or more implementations, each of the audio speakers 104a and 104b is designed to generate audible sound below a threshold frequency, such as 200 Hz or less. In this regard, each of the audio speakers 104a and 104b may generate audible sound in the form of bass. Alternatively, in other implementations, the threshold frequency is 10 kilohertz (kHz) or less.

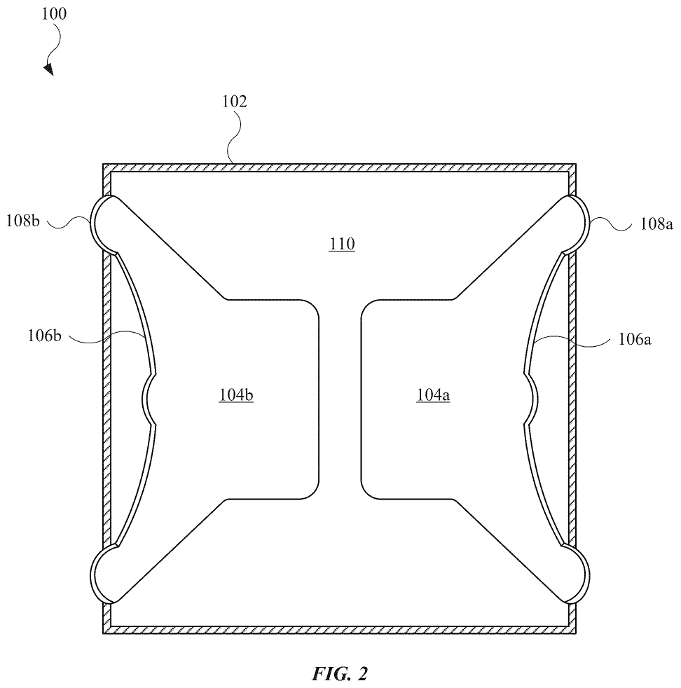

FIG. 2 illustrates a partial cross sectional view of the speaker assembly 100 shown in FIG. 1, showing additional features of the speaker assembly 100, in accordance with one or more aspects of the present disclosure. As shown, the audio speaker 104a may include a diaphragm 106a and a surround 108a. Similarly, the audio speaker 104b may include a diaphragm 106b and a surround 108b. Although not shown, each of the audio speakers 104a and 104b may include a voice coil and a magnet, with the respective voice coils coupled with the diaphragm 106a and the diaphragm 106b. Each of the voice coils are designed to oscillate when receive an alternating electrical current, which causes the voice coil to generate an electromagnet with a corresponding alternating magnetic field that reacts (e.g., magnetically couples and repels) with the respective magnet. The oscillating voice coil acoustically drive the diaphragm 106a and the diaphragm 106b.

Also, the housing 102 may define a volume 110 that is shared by the audio speakers 104a and 104b. In one or more implementations, the volume 110 takes the form of a back volume. Based on the volume 110 being shared by the audio speakers 104a and 104b, the volume 110 may be referred to as a shared back volume.

In one or more implementations, the speaker assembly 100 takes the form of a dipole speaker assembly. In this regard, the audio speaker 104a may generate the same or similar audible sound as that of the audio speaker 104b. However, respective generated soundwaves that provide the audible sound are out of phase (e.g., 180 degrees out of phase) with respect to each other. Put another way, the respective soundwaves generated by the audio speakers 104a and 104b are synchronized in that the audio speakers 104a and 104b operate at the same rate and frequency, but are out of sync with respect to the phase. By generating out-of-phase soundwaves, at least some of the soundwaves generated by the audio speaker 104a are canceled by the audible sound of the audio speaker 104b, and at least some of the soundwaves generated by the audio speaker 104b are canceled by the audible sound of the audio speaker 104a. Thus, the audible sound is canceled based on canceling soundwaves.

In the foregoing examples, the speaker assemblies shown and/or described may include any features or components previously described herein for a speaker assembly (e.g., the speaker assembly 100 shown in FIG. 2) Accordingly, at least some speaker assemblies shown and/or described herein may function as a dipole speaker.

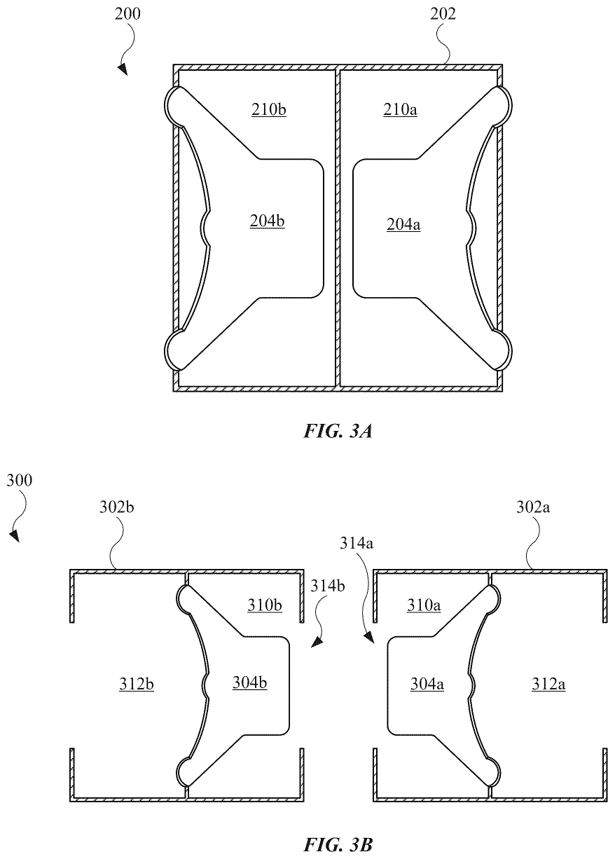

FIG. 3A and FIG. 3B illustrate partial cross sectional views of alternate embodiments of speaker assemblies, in accordance with one or more aspects of the present disclosure. Referring to FIG. 3A, a speaker assembly 200 includes an audio speaker 204a and an audio speaker 204b. The speaker assembly 200 may further include a housing 202 that carries the audio speakers 204a and 204b. The housing 202 may define a volume 210a for the audio speaker 204a and a volume 210b for the audio speaker 204b. In one or more implementations, the volume 210a and the volume 210b form a back volume for the audio speaker 204a and the audio speaker 204b, respectively. As shown, the volume 210a is separate from the volume 210b, and the audio speakers 204a and 204b do not share a volume (e.g., back volume). By providing a dedicated back volume for each of the audio speakers 204a and 204b, air stiffness due to operation of one of the audio speakers (e.g., the audio speaker 204a) may not affect the operation of another audio speaker (e.g., the audio speaker 204b).

Referring to FIG. 3B, a speaker assembly 300 includes a housing 302a that carries an audio speaker 304a and a housing 302b that carries an audio speaker 304b. As shown, the housing 302a is separate from the housing 302b. The housing 302a may include a volume 310a and a volume 312a. In one or more implementations, the volume 310a and the volume 312a take the form of a back volume and a front volume, respectively. Further, the housing 302a may include an opening 314a to which the volume 310a opens. Based on the opening 314a, the housing 302a may form an open baffle for the audio speaker 304a. Similarly, the housing 302b may include a volume 310b and a volume 312b that take the form of a back volume and a front volume, respectively. Also, the housing 302b may include an opening 314b to which the volume 310b opens. Based on the opening 314b, the housing 302b may form an open baffle for the audio speaker 304b.

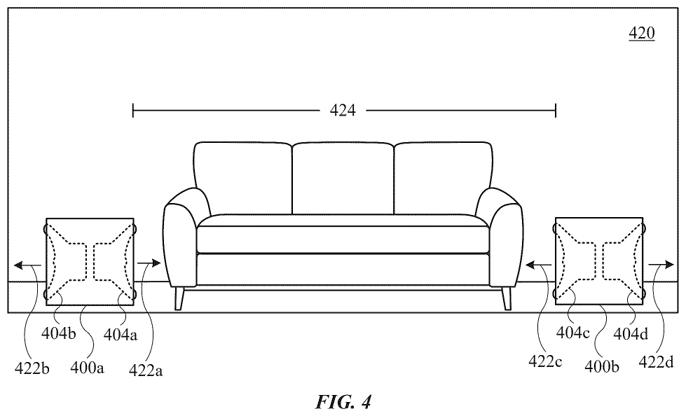

FIG. 4 illustrates a perspective view of an environment 420 with multiple speaker assemblies, in accordance with one or more aspects of the present disclosure. As shown, a speaker assembly 400a and a speaker assembly 400b are located in the environment 420. The environment 420 may take the form of a listening environment for listening to audible sound generated by the speaker assembly 400a and the speaker assembly 400b. As non-limiting examples, the environment 420 may include a room in a den (e.g., house, apartment) or in an office. In one or more implementations, each of speaker assembly 400a and the speaker assembly 400b may be substituted with another speaker assembly shown and/or described herein.

The speaker assembly 400a may include an audio speaker 404a and an audio speaker 404b, and the speaker assembly 400b may include an audio speaker 404c and an audio speaker 404d. Similar to the audio speakers 104a and 104b (shown in FIG. 2), each of the audio speakers 404a, 404b, 404c, and 404d may take the form of a drive unit designed to generate soundwaves to produce audible sound. The audio speakers 404a and 404b are disposed in a housing of the speaker assembly 400a and the audio speakers 404c and 404d are disposed in a housing of the speaker assembly 400b. Further, several arrows indicate a direction (or approximate direction) of travel of soundwaves generated by the respective audio speakers. For example, the audio speaker 404a may generate soundwaves in a direction of an arrow 422a and the audio speaker 404b may generate soundwaves in a direction of an arrow 422b. As shown, the direction of the arrow 422a is opposite of the direction of the arrow 422b. Further, the audio speaker 404c may generate soundwaves in a direction of an arrow 422c and the audio speaker 404d may generate soundwaves in a direction of an arrow 422d. As shown, the direction of the arrow 422c is opposite of the direction of the arrow 422d.

In one or more implementations, each of the speaker assembly 400a and the speaker assembly 400b takes the form of a dipole speaker. In this regard, the soundwaves from the audio speaker 404a may cancel, or at least partially cancel, the soundwaves from the audio speaker 404b, and the soundwaves from the audio speaker 404b may cancel, or at least partially cancel, the soundwaves from the audio speaker 404a. Similarly, the soundwaves from the audio speaker 404c may cancel, or at least partially cancel, the soundwaves from the audio speaker 404d, and the soundwaves from the audio speaker 404d may cancel, or at least partially cancel, the soundwaves from the audio speaker 404c.

Further, the speaker assembly 400a may be separated from the speaker assembly 400b by a dimension 424 (e.g., horizontal distance). The dimension 424 represents a distance or separation between the speaker assembly 400a and the speaker assembly 400b that still allows respective soundwaves from the speaker assembly 400a and the speaker assembly 400b meet to either constructively additive, or at least partially additive, together or cancel, or at least partially cancel, each other. The dimension 424 may be adjusted based on factors such as the frequency and/or amplitude of the soundwaves generated by the speaker assembly 400a and the speaker assembly 400b.

In example implementation, the audio speaker 404a may emit soundwaves in a direction of the arrow 422a and the audio speaker 404c may emit soundwaves in a direction of the arrow 422c. The respective soundwaves from the audio speakers 404a and 404c may be synchronized and in phase with each other. As a result, at least some of the respective soundwaves from the audio speakers 404a and 404c may constructively additive together. However, the respective soundwaves generated by the audio speakers 404a and 404d are synchronized in that the audio speakers 404a and 404d operate at the same rate and frequency, but the respective soundwaves from the audio speakers 404a and 404d are out of phase with each other. As a result, the respective soundwaves from the audio speakers 404a and 404d cancel, or at least partially cancel, each other. Similarly, the respective soundwaves generated by the audio speakers 404b and 404c are synchronized in that the audio speakers 404b and 404c operate at the same rate and frequency, but the respective soundwaves from the audio speakers 404b and 404c are out of phase with each other, and accordingly, the respective soundwaves from the audio speakers 404b and 404c may cancel with each other.

Accordingly, the soundwaves from the audio speaker 404a may be at least partially canceled by respective soundwaves from the audio speaker 404b and 404d, and the soundwaves from the audio speaker 404c may be at least partially canceled by respective soundwaves from the audio speaker 404b and 404d. While a user (or users) of the speaker assembly 400a and the speaker assembly 400b may still hear audible sound, the audible sound may not travel as far throughout the environment 420 due to the canceling effect, as a result, the audible sound from the speaker assembly 400a and the speaker assembly 400b may be limited, or substantially limited, to within the environment 420. Beneficially, persons outside of the environment 420 are less likely to hear the audible sound as a result of the aforementioned canceling. Moreover, when the speaker assembly 400a and the speaker assembly 400b emit audible sound with soundwaves at or below a threshold frequency (e.g., 200 Hz), the resultant force from the soundwaves is limited or canceled, based on the canceled soundwaves, thereby limiting unwanted shaking or rattling of objects in or near the environment 420.

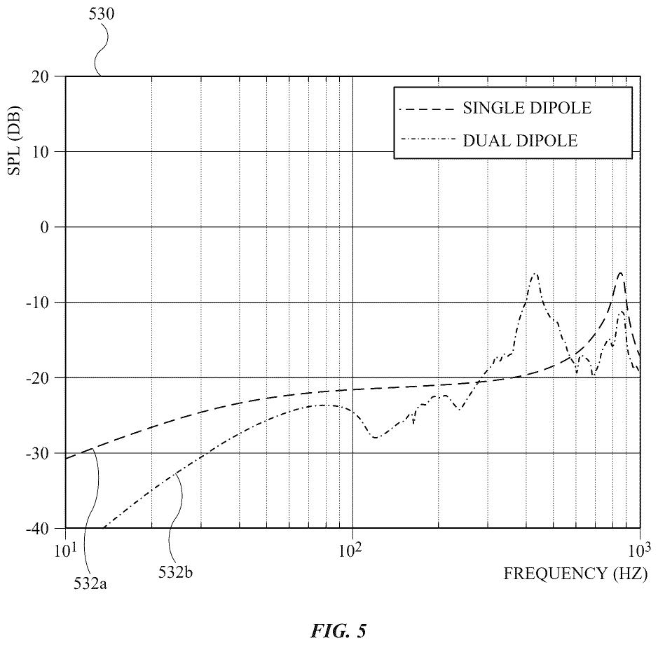

FIG. 5 illustrates a graph 530 showing SPL versus frequency for a dipole speaker and for a set of multiple dipole speakers, in accordance with one or more aspects of the present disclosure. The SPL is measured in decibels (dB) and the frequency is measured in Hz. A plot 532a shows the SPL for a dipole speaker and a plot 532b shows the SPL for multiple dipole speakers designed to interact with each other (e.g., a dual dipole system with the speaker assembly 400a and the speaker assembly 400b shown in FIG. 4). By comparing the plots 532a and 532b, it can be seen that the SPL for multiple dipoles is less than that for the dipole speaker when the frequency is 200 Hz or less. Accordingly, the traditional bass sounds may be more actively canceled using a multiple dipole system. Also, the SPL may be normalized across frequencies in a user listening position so the user would experience the same amount of low-frequency sound (e.g., bass) for either configuration in the user listening position.

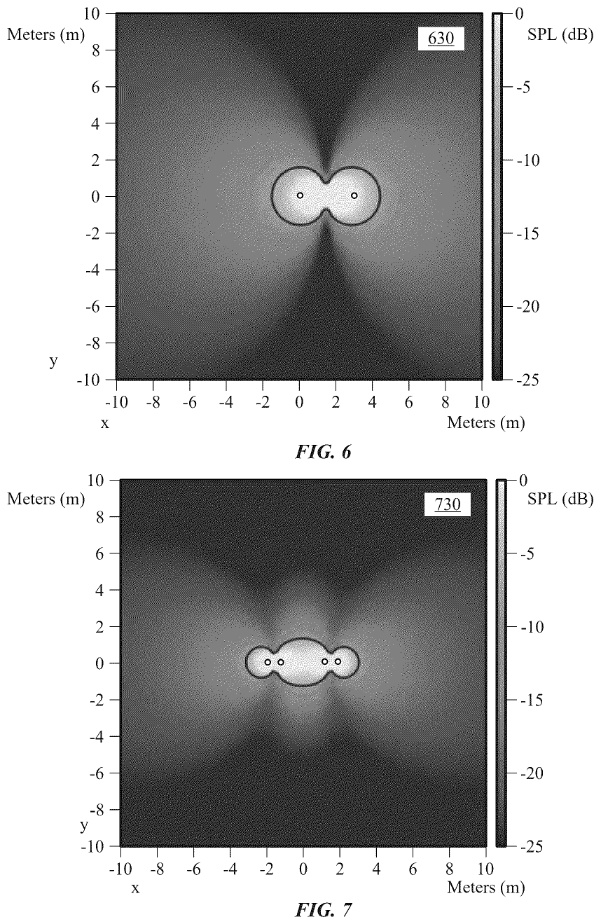

FIG. 6 and FIG. 7 illustrate graphs showing SPL of soundwaves from a dipole speaker and from multiple dipole speakers, respectively, at various distances from a reference point. The SPL is measured in decibels (dB) and the distance is measured in meters (m). As a reference, a single frequency (e.g., 100 Hz) soundwave is selected and the SPL of the soundwave is measured at different locations from the origin. As an example, in FIG. 6, a user of a dipole speaker is located at the origin (0,0) of an x-y coordinate system, and the dipole speaker may be positioned off center (e.g., within 1 m to the right or left of the origin (0,0)).

Referring to FIG. 6, a graph 630 SPL of a single dipole speaker (e.g., speaker assembly 100 shown in FIG. 1) generating soundwaves from an origin (0,0) is shown. The two dots in the graph 630 represent an audio speaker of a dipole speaker. The darker shaded area between the dots represents relatively lower measured SPL, while the lighter shaded areas represents relatively higher measured SPL. As shown, the soundwaves are generally canceled along a vertical line passing through the origin. However, in other locations, the measured SPL at selected points is −15 dB or greater.

Referring to FIG. 7, a graph 730 of measured SPL from multiple dipole speakers (e.g., the speaker assembly 400a and the speaker assembly 400b shown in FIG. 4) generating soundwaves. In FIG. 7, a user is positioned at the origin (0,0), a first dipole speaker may be positioned to the left of the origin (0,0) (e.g., within 1 m to the left of the origin (0,0)), and a second dipole speaker may be positioned to the right of the origin (0,0) (e.g., within 1 m to the right of the origin (0,0)). The two adjacent sets dots in the graph 730 represent two audio speakers of a respective dipole speaker (e.g., the audio speakers 404a and 404b of the speaker assembly 400a, and the audio speakers 404c and 404d of the speaker assembly 400b, both shown in FIG. 4). As compared the graph 630, the graph 730 shows a lower measured SPL at the same distances. For example, the graph 730 shows the measured SPL at 6 m (e.g., +6 m and −6 m) along the y-axis is lower as compared to the same/corresponding locations on the graph 630. Accordingly, the graph 730 illustrates a multi-dipole system may provide added cancellation of soundwaves relative to single dipole systems.

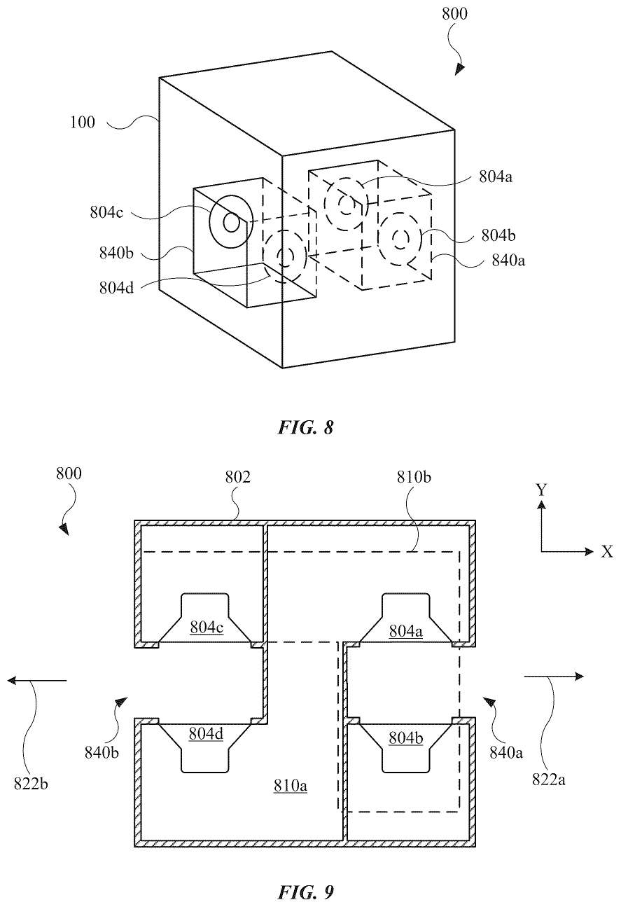

FIG. 8 illustrates a perspective view of a speaker assembly 800 that includes multiple sets of audio speakers, in accordance with one or more aspects of the present disclosure. As shown, the speaker assembly 800 includes a housing 802. The speaker assembly 800 may further include an audio speaker 804a, an audio speaker 804b, an audio speaker 804c, and an audio speaker 804d, each of which are carried by the housing 802. The housing 802 may define an opening 840a for the audio speakers 804a and 804b. The housing 802 may further define an opening 840b for the audio speakers 804c and 804d.

FIG. 9 illustrates a partial cross sectional view of the speaker assembly 800 shown in FIG. 8, showing additional features of the speaker assembly 800, in accordance with one or more aspects of the present disclosure. The audio speakers 804a and 804b may generate soundwaves that exit the housing 802, via the opening 840a, in a direction of an arrow 822a. Also, the audio speakers 804c and 804d may generate soundwaves that exit the housing 802, via the opening 840b, in a direction of an arrow 822b. As shown, the arrows 822a and 822b are in opposing directions. Further, the soundwaves from the audio speaker 804a may be out of phase with respect to the soundwaves of the audio speaker 804d. Similarly, the soundwaves of the audio speaker 804c may be out of phase with respect to the soundwaves of the audio speaker 804b. In this regard, the audio speakers 804a and 804d may form a dipole speaker, and the audio speakers 804b and 804c may form a dipole speaker.

Also, the audio speakers 804a and 804d may share a volume 810a (e.g., back volume). Additionally, the audio speakers 804b and 804c may share a volume 810b (e.g., back volume) shown as dotted lines. The volume 810b may be above or below the volume 810a within the housing 802. In one or more implementations, the volumes 810a and 810b are the same or approximately the same (e.g., same cubic meters). During operation, some components of dipole speakers may be driven in different directions. For example, when a diaphragm of the audio speaker 804a moves in along a positive direction of the Y-axis, a diaphragm of the audio speaker 804d moves in along a positive direction of the Y-axis. Conversely, when the diaphragm of the audio speaker 804a moves in along the negative direction of the Y-axis, the diaphragm of the audio speaker 804d moves in along a negative direction of the Y-axis. Based on the movement of the respective diagrams in opposite directions, the air within the volume 810a may be minimally or negligibly compressed or expanded. This may limit or prevent a force (or forces) from the speaker assembly 800 that otherwise causes shaking of other nearby objects. A similar relationship between the audio speakers 804b and 804c may occur during operation to minimally or negligibly expand or compress the air within the volume 810b.

Further, during operation, when the diaphragm of the audio speaker 804a moves in along a negative direction of the Y-axis, the diaphragm of the audio speaker 804b moves in along a positive direction of the Y-axis. As a result, the mechanical force from the movement of the audio speaker 804a (e.g., force transmitted through the enclosure of the audio speaker 804a through the floor) may be canceled by the mechanical force from movement of the audio speaker 804b. Conversely, when the diaphragm of the audio speaker 804a moves in along a positive direction of the Y-axis, the diaphragm of the audio speaker 804b moves in along a negative direction of the Y-axis. In this regard, the expansion force due to movement of air provided by the audio speaker 804a may be canceled by the expansion force provided by the audio speaker 804b. The respective diaphragms of the audio speaker 804c and 804d may function in a similar manner. Beneficially, by providing additional force canceling capabilities, the speaker assembly 800 is further less susceptible to shaking, and is less likely to shake other nearby objects. It should be noted that when the speaker assembly 800 shown in FIGS. 8 and 9 is paired with an additional speaker assembly similar to the speaker assembly 800, the pair of speaker assemblies may be spaced apart (e.g., similar to the speaker assembly 404a and the speaker assembly 404b shown FIG. 4) and function as a multiple-dipole assembly for sound mitigation or cancel as described herein.

While the speaker assembly 800 shown in FIG. 8 and FIG. 9 is characterized as having multiple back volumes (e.g., back volumes 810a and 810b shown in FIG. 9), in one or more implementations, the speaker assembly 800 includes a single back volume utilized by each of the audio speakers 804a, 804b, 804c, and 804d. The single back volume may include the same, or substantially similar, volume as that of a combination of the back volumes 810a and 810b. Alternatively, the single back volume may include a different volume than that of a combination of the back volumes 810a and 810b.

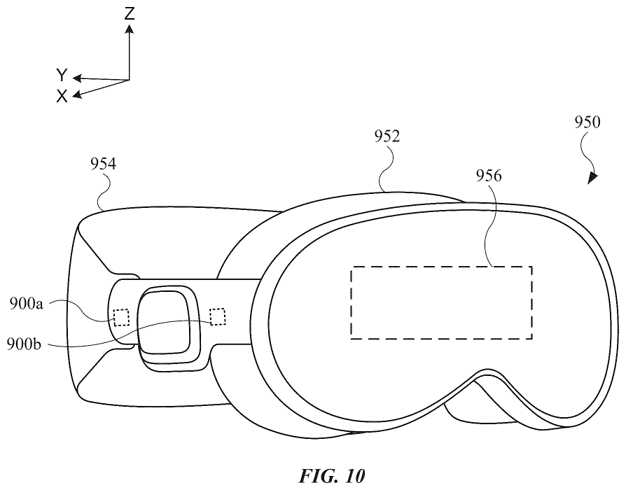

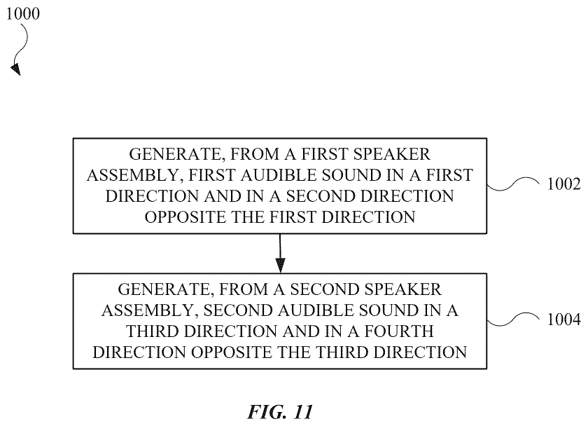

FIG. 10 illustrates a perspective view of an embodiment of an electronic device 950, in accordance with one or more aspects of the present disclosure. In one or more implementations, the electronic device 950 takes the form of an MR device, such as an AR device or a VR device. As shown, the electronic device 950 may include a housing 952 and a band 954 coupled with the housing 952. The band 954 may fit onto a user's head and subsequently the housing 952 fits over the user's eyes. When the electronic device 950 takes the form of a pass-through MR device, the electronic device 950 may further include a display 956 (representative of one or more displays) designed to present visual information in the form of textual information, still images, and/or motion images (e.g., video). Alternatively, when the electronic device 950 takes the form of a see-through MR device, the electronic device 950 may further include a lens (e.g., transparent lens) that replaces the display 956, and may include a display or projector located elsewhere.

Also, the electronic device 950 may further include a speaker assembly 900a and a speaker assembly 900b. Each of the speaker assembly 900a and the speaker assembly 900b may take the form of any speaker assembly shown and/or described herein. In this regard, the speaker assembly 900a and the speaker assembly 900b may form a dual dipole speaker system (e.g., similar to the speaker assembly 400a and the speaker assembly 400b shown in FIG. 45). The speaker assembly 900a and the speaker assembly 900b may be designed to output audible sound that is synchronized with the visual information presented by the display 956 or by another display or projector of the electronic device 950. Also, when the electronic device 950 is positioned on a user, the user's ear may be positioned between the speaker assembly 900a and the speaker assembly 900b (similar to placing the user at the origin (0,0) in FIG. 7). Beneficially, the speaker assembly 900a and the speaker assembly 900b may provide canceling soundwaves to constrain or minimize sound travel, thus enhancing user privacy for users of the electronic device 950. Also, the speaker assembly 900a and the speaker assembly 900b may collectively provide a more consistent response over multiple users as compared to that of an electronic device with a single speaker (e.g., single dipole speaker).

In one or more implementations, the speaker assembly 900a and the speaker assembly 900b are arranged on the electronic device 950 (e.g., within the band 954) to limit the travel of soundwaves in a particular direction or directions. This may occur through canceling soundwaves generated by the speaker assembly 900a and the speaker assembly 900b. For example, the soundwaves generated by the speaker assembly 900a and the speaker assembly 900b may undergo minimal cancellation along the Z-axis. However, generated by the speaker assembly 900a and the speaker assembly 900b may undergo cancellation along the X-direction, the Y-direction, or some combination of the X-and Y-direction. As a result, persons (other than the user) in proximity to the electronic device 950 may not hear the audible sound from the speaker assembly 900a and the speaker assembly 900b. Beneficially, the electronic device 950 may provide additional privacy. However, based on the proximity of the speaker assembly 900a and the speaker assembly 900b to a user's ear when the user is wearing the electronic device 950, the user may still hear the audible sound despite cancellation thereof. It should be noted that the speaker assembly 900a and the speaker assembly 900b may be representative of additional speaker assemblies such that the electronic device 950 includes multiple speaker assemblies for each ear of a user.

Also, while a particular orientation of the speaker assembly 900a and the speaker assembly 900b is shown, the orientation of the speaker assembly 900a and the speaker assembly 900b may be altered (e.g., rotated) while still providing the same soundwaves cancellation effects. Further, based in part on the smaller footprint, the speaker assembly 900a and the speaker assembly 900b may be used in soundwave cancelation applications in which the soundwaves are not only in the low-frequency range (e.g., 40 Hz to 200 Hz) but also in the mid-range (e.g., 200 Hz to 2,000 Hz) frequencies.

FIG. 11 illustrates a flow diagram showing an example of a process 1000 for managing audible sound, in accordance with one or more aspects of the present disclosure. For explanatory purposes, the process 1000 is primarily described herein with reference to speaker assemblies shown and/or described in FIGS. 1-10. However, the process 1000 is not limited to the speaker assemblies shown and/or described in FIGS. 1-10, and one or more blocks (or operations) of the process 1000 may be performed by one or more other components and other suitable audio transducers. Further for explanatory purposes, the blocks of the process 1000 are described herein as occurring in serial, or linearly. However, multiple blocks of the process 1000 may occur in parallel. In addition, the blocks of the process 1000 need not be performed in the order shown and/or one or more blocks of the process 1000 need not be performed and/or can be replaced by other operations.

At block 1002, a first speaker assembly generates first audible sound in a first direction and in a second direction opposite the first direction. The first audible sound may be generated by first soundwaves from the first speaker assembly.

At block 1004, a second speaker assembly generates second audible sound in a third direction and in a fourth direction opposite the third direction. The second audible sound may be generated by second soundwaves from the second speaker assembly. In one or more implementations, the first audible sound in the first direction at least partially cancels i) the first audible sound in the second direction and ii) the second audible sound in the third direction. Also, each of the speaker assemblies may take the form of a dipole speaker.

FIG. 11 illustrates an electronic system 1100 with which one or more implementations of the subject technology may be implemented. The electronic system 1100 can be, and/or can be a part of, the electronic device 950 as shown in FIG. 10. The electronic system 1100 may include various types of computer readable media and interfaces for various other types of computer readable media. The electronic system 1100 includes a bus 1110, one or more processing units 1114, a system memory 1104 (and/or buffer), a ROM 1112, a permanent storage device 1102, an input device interface 1106, an output device interface 1108, and one or more network interfaces 1116, or subsets and variations thereof.

The bus 1110 collectively represents all system, peripheral, and chipset buses that communicatively connect the numerous internal devices of the electronic system 1100. In one or more implementations, the bus 1110 communicatively connects the one or more processing units 1114 with the ROM 1112, the system memory 1104, and the permanent storage device 1102. From these various memory units, the one or more processing units 1114 retrieves instructions to execute and data to process in order to execute the processes of the subject disclosure. The one or more processing units 1114 can be a single processor or a multi-core processor in different implementations.

The ROM 1112 stores static data and instructions that are needed by the one or more processing units 1114 and other modules of the electronic system 1100. The permanent storage device 1102, on the other hand, may be a read-and-write memory device. The permanent storage device 1102 may be a non-volatile memory unit that stores instructions and data even when the electronic system 1100 is off. In one or more implementations, a mass-storage device (such as a magnetic or optical disk and its corresponding disk drive) may be used as the permanent storage device 1102.

In one or more implementations, a removable storage device (such as a flash drive, and its corresponding disk drive) may be used as the permanent storage device 1102. Like the permanent storage device 1102, the system memory 1104 may be a read-and-write memory device. However, unlike the permanent storage device 1102, the system memory 1104 may be a volatile read-and-write memory, such as random access memory. The system memory 1104 may store any of the instructions and data that one or more processing units 1114 may need at runtime. In one or more implementations, the processes of the subject disclosure are stored in the system memory 1104, the permanent storage device 1102, and/or the ROM 1112 (which are each implemented as a non-transitory computer-readable medium). From these various memory units, the one or more processing units 1114 retrieves instructions to execute and data to process in order to execute the processes of one or more implementations.

The bus 1110 also connects to the input device interface 1106 and output device interface 1108. The input device interface 1106 enables a user to communicate information and select commands to the electronic system 1100. Input devices that may be used with the input device interface 1106 may include, for example, alphanumeric keyboards and pointing devices (also called “cursor control devices”). The input device interface 1106 may enable, for example, the display of images generated by electronic system 1100. Output devices that may be used with the input device interface 1106 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 1110 may also couple the electronic system 1100 to one or more networks and/or to one or more network nodes, such as the speaker assembly 100 shown in FIG. 1, through the one or more network interfaces 1116. In this manner, the electronic system 1100 can be a part of a network of computers (such as a LAN, a wide area network (“WAN”), or an Intranet, or a network of networks, such as the Internet. Any or all components of the electronic system 1100 can be used in conjunction with the subject disclosure.

The bus 1110 may also couple the electronic system 1100 to one or more networks and/or to one or more network nodes, such as the speaker assembly 100 shown in FIG. 1, through the one or more network interfaces 1116. In this manner, the electronic system 1100 can be a part of a network of computers (such as a LAN, a wide area network (“WAN”), or an Intranet, or a network of networks, such as the Internet. Any or all components of the electronic system 1100 can be used in conjunction with the subject disclosure.

In one or more aspects of the present disclosure, a system is described. The system may include a first speaker assembly configured to emit first audible sound in a first direction and in a second direction opposite the first direction. The system may further include a second speaker assembly configured to emit second audible sound in a third direction and in a fourth direction opposite the third direction. The first audible sound in the first direction may at least partially cancels i) the first audible sound in the second direction and ii) the second audible sound in the third direction.

In one or more aspects of the present disclosure, a head-mountable device is described. The head-mountable device may include a housing. The head-mountable device may further include a band coupled with the housing. The band may be configured to wrap around a head of a user. The head-mountable device may include a speaker assembly carried by the band and configured to provide audible sound. The speaker assembly may include a first speaker assembly configured to emit first audible sound. The speaker assembly may further include a second speaker assembly configured to emit second audible sound. The second audible sound may be configured to be i) at least partially in phase with respect to the first audible sound and ii) at least partially out of phase with respect to the first audible sound.

In one or more aspects of the present disclosure, a method is described. The method may include a generating, from a first speaker assembly, first audible sound in a first direction and in a second direction opposite the first direction. The method may further include generating, from a second speaker assembly, second audible sound in a third direction and in a fourth direction opposite the third direction. The first audible sound in the first direction may at least partially cancels i) the first audible sound in the second direction and ii) the second audible sound in the third direction.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S. C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A system, comprising:
a housing;
a first speaker assembly disposed in the housing, the first speaker assembly comprising i) a first audio speaker configured to emit first audible sound in a first direction and ii) a second audio speaker in a second direction opposite the first direction; and
a second speaker assembly disposed in the housing, the second speaker assembly comprising i) a third audio speaker configured to emit second audible sound in a third direction and ii) a fourth audio speaker in a fourth direction opposite the third direction, wherein the first audible sound in the first direction at least partially cancels i) the first audible sound in the second direction and ii) the second audible sound in the third direction.

2. The system of claim 1, wherein:
the first speaker assembly is configured to emit the first audible sound below a threshold frequency, and
the second speaker assembly configured to emit the second audible sound below the threshold frequency.

3. The system of claim 2, wherein the threshold frequency is 200 Hertz or less.

4. The system of claim 1, wherein:
the first audible sound in the first direction is out of phase with respect to the i) the first audible sound in the second direction and ii) the second audible sound in the third direction, and
the second audible sound in the fourth direction is out of phase with respect to the i) the first audible sound in the second direction and ii) the second audible sound in the third direction.

5. The system of claim 1, wherein the second speaker assembly is oriented with respect to the first speaker assembly such that the second audible sound in the third direction is directed toward the first audible sound in the second direction.

6. (canceled).

7. (canceled).

8. The system of claim 1, wherein:
the housing comprises a first back volume and a second back volume, p1 the first audio speaker and the fourth audio speaker share the first back volume, and p1 the second audio speaker and the third audio speaker share the second back volume.

9. The system of claim 1, wherein:
the first audio speaker is out of phase with respect to the fourth audio speaker, and
the second audio speaker is out of phase with respect to the third audio speaker.

10. A head-mountable device, comprising:
a housing;
a band coupled with the housing, the band configured to wrap around a head of a user; and
a speaker assembly coupled to the band and configured to provide audible sound, the speaker assembly comprising:
a first speaker assembly configured to emit first audible sound; and
a second speaker assembly configured to emit second audible sound, wherein the second audible sound is configured to be i) at least partially in phase with respect to the first audible sound and ii) at least partially out of phase with respect to the first audible sound.

11. The head-mountable device of claim 10, wherein the first audible sound is configured to be i) at least partially additive with respect to the second audible sound and ii) at least partially cancel the second audible sound.

12. The head-mountable device of claim 10, wherein:
the first speaker assembly is configured to emit the first audible sound in a first direction and in a second direction opposite the first direction; and
the second speaker assembly is configured to emit the second audible sound in a third direction and in a fourth direction opposite the third direction, wherein the first audible sound in the first direction at least partially cancels i) the first audible sound in the second direction and ii) the second audible sound in the third direction.

13. The head-mountable device of claim 12, wherein:
the first audible sound in the first direction is out of phase with respect to the i) the first audible sound in the second direction and ii) the second audible sound in the third direction, and
the second audible sound in the fourth direction is out of phase with respect to the i) the first audible sound in the second direction and ii) the second audible sound in the third direction.

14. The head-mountable device of claim 12, wherein the second speaker assembly is oriented with respect to the first speaker assembly such that the second audible sound in the third direction is directed toward the first audible sound in the second direction.

15. The head-mountable device of claim 10, wherein:
the first speaker assembly is disposed in a first housing, and
the second speaker assembly is disposed in a second housing separate from the first housing.

16. The head-mountable device of claim 12, wherein the speaker assembly further comprises a housing, wherein the first speaker assembly and the second speaker assembly are disposed in the housing.

17. The head-mountable device of claim 16, wherein:
the first speaker assembly comprises a first audio speaker and a second audio speaker, and
the second speaker assembly comprises a third audio speaker and a fourth audio speaker.

18. A method for managing audible sound, the method comprising:
generating, from a first speaker assembly comprising a first audio speaker and a second audio speaker in a first housing, first audible sound in a first direction and in a second direction opposite the first direction; and
generating, from a second speaker assembly comprising a third audio speaker and a fourth audio speaker in a second housing separate from the first housing, second audible sound in a third direction and in a fourth direction opposite the third direction, wherein the first audible sound in the first direction at least partially cancels i) the first audible sound in the second direction and ii) the second audible sound in the third direction.

19. The method of claim 18, wherein:
generating the first audible sound in the first direction comprises generating, from the first audio speaker of the first speaker assembly, the first audible sound in the first direction,
generating the first audible sound in the second direction comprises generating, from the second audio speaker of the first speaker assembly, the first audible sound in the second direction,
generating the second audible sound in the third direction comprises generating, from the third audio speaker of the second speaker assembly, the second audible sound in the third direction, and
generating the first audible sound in the second direction comprises generating, from the fourth audio speaker of the second speaker assembly, the second audible sound in the fourth direction.

20. The method of claim 18, wherein the first audible sound in the first direction and the second audible sound in the fourth direction are out of phase with respect to the first audible sound in the second direction and the second audible sound in the third direction.

21. The method of claim 18, further comprising:
generating, using the first audio speaker in a first back volume, the first audible sound in the first direction; and
generating, using the second audio speaker in a second back volume separate from the first back volume, the first audible sound in the second direction.

22. The system of claim 1, wherein the housing comprises:
a first opening for the first audio speaker and the second audio speaker; and
a second opening for the third audio speaker and the fourth audio speaker.
